(19) United States
(12) Patent Application Publication
(10) Pub. No.: US 2025/0281345 A1
(43) Pub. Date: Sep. 11, 2025

(54) THERAPEUTIC BRACE UTILIZING ACTIVE RELEASE TECHNOLOGY

(71) Applicant: Angie Wong, Los Angeles, CA (US)

(72) Inventor: Angie Wong, Los Angeles, CA (US)

(21) Appl. No.: 18/600,763

(22) Filed: Mar. 10, 2024

(51) Int. Cl. A61H 7/00

(52) U.S. Cl. CPC A61H 7/001; A61H 2201/10; A61H 2201/165; A61H 2201/1695

(57) ABSTRACT

A novel, wearable therapeutic medical device that seamlessly integrates myofascial release therapy technology into daily life by discreetly targeting trigger points and otherwise dysfunctional tissue in order to relieve associated pain, discomfort, stiffness, and tension. Individuals wearing this novel therapeutic medical device are capable of continuing to go about their everyday activities while effortlessly improving their musculoskeletal health.

### FIELD OF THE PRESENT DISCLOSURE

This disclosure relates generally to medical equipment, and more specifically to a novel wearable therapeutic brace that utilizes active release technology (“ART”) to dynamically treat and relieve myofascial pain, discomfort, stiffness, and tension and to increase blood circulation and promote healing.

### BACKGROUND OF THE RELATED ART

Myofascial release therapy has gained significant popularity as an effective approach to addressing and healing myofascial pain syndrome, a condition characterized by chronic pain and discomfort stemming from the fascia, the connective tissue surrounding muscles.

One of the most effective forms of myofascial release therapy is called Active Release Therapy (“ART”) which involves gentle massage of the areas of pain or discomfort by a trained practitioner who focuses on finding the precise locations where the pain or discomfort is most intense, called trigger points. Once the trigger points are identified, the practitioner targets those areas with specialized therapeutic massage techniques that cause the identified areas to experience compression, traction, and various twisting or shear forces with the goal of releasing tension, reducing stiffness, and increasing blood circulation to promote healing.

Myofascial therapy is especially popular with individuals who desire a more noninvasive, holistic, and natural approach to address the underlying causes and heal such aches and pains, especially among individuals who are skeptical of traditional medical approaches like the use of surgery, pain killers, and other medications.

As individuals learn more about myofascial therapy, they recognize that the benefits also extend well beyond addressing pain and discomfort, this holistic therapy also improves flexibility and promotes healing which enhances the individual's overall well-being.

However, despite the evident benefits of myofascial release therapy, it is important to acknowledge certain limitations associated with this approach. One significant drawback is the necessity for therapy sessions with a trained practitioner which can pose challenges for individuals with busy schedules, geographical constraints, or those who are otherwise facing restrictions that limit their ability to access regular in-person sessions.

Moreover, the intermittent nature of sessions may result in excessive gaps between treatments, impeding the consistent management of myofascial pain syndrome, and hindering the healing process. Recognizing this limitation prompts exploration into complementary strategies, such as at-home exercises or self-myofascial release techniques, which individuals can incorporate between sessions to maximize progress and manage symptoms more effectively.

Another noteworthy limitation of incorporating myofascial release therapy into one's routine lies in the demanding schedules that many individuals face. For those whose daily lives are dominated by lengthy commutes and demanding work hours, finding time for even self-myofascial release techniques can be a considerable challenge. Such constraints on individual's time can lead to difficulties in maintaining a consistent and comprehensive myofascial release routine, potentially hindering the ultimate effectiveness of the therapy.

Recognizing the time constraints faced by individuals with busy schedules, especially during commuting and working hours, it becomes essential to explore myofascial release techniques that can be seamlessly integrated into these daily activities. There exists a need to explore techniques that can be utilized during commutes, desk-friendly techniques, and techniques that can be integrated, whether seated or standing, into the daily routines of individuals with busy schedules so that myofascial pain syndrome can be addressed in an efficient and non-time consuming manner that aligns with busy lifestyles and provides access to the therapeutic benefits of myofascial release, even to those with hectic schedules.

Additionally, it would be beneficial to incorporate other legacy holistic therapies believed to influence a person's physical well-being with myofascial release therapy. One such legacy holistic therapy can could be integrated seamlessly with myofascial release therapy is crystal therapy. Proponents of crystal therapy assert that certain crystals possess healing vibrations that can promote balance and alleviate discomfort in the body.

By placing crystals on specific trigger points or incorporating crystals into myofascial massage sessions, practitioners could combine the positive healing energies associated with the crystals with the physical therapeutic manipulation of the myofascial release therapy to achieve results that could surpass either therapy alone. Advocates suggest that crystals, such as amethyst and clear quartz, can enhance relaxation, reduce inflammation, and encourage the flow of vital energy throughout the body. If other such holistic therapies were incorporated into myofascial release therapy, synergistic healing benefits could be achieved.

The present disclosure distinguishes over the related art providing heretofore unknown advantages as described in the following summary.

### BRIEF SUMMARY OF THE INVENTION

The present disclosure describes a novel, wearable therapeutic medical device designed to seamlessly integrate myofascial release therapy technology into daily life and to provide an inexpensive and accessible means of providing relief from pain, discomfort, stiffness, and tension, and to provide increased circulation and to promote healing through certain innovative features.

Similar to legacy in-person myofascial release therapy, the presently disclosed apparatus provides physical manipulation to targeted dysfunctional myofascial tissues resulting in increased flexibility and circulation which initiates and promotes natural healing. However, unlike traditional in-person myofascial release therapy, the source of the force and energy used to physically manipulate the targeted tissue is not provided by a licensed practitioner but rather is provided by the interaction between the presently disclosed novel therapeutic device and the motion of individual's own body as the individual goes about their routine daily activities.

Structurally, the novel therapeutic device includes at least one firm panel contoured to compliment the particular part of the individual's body that is targeted as being in need of treatment. Each panel supports at least one pressure point knob facing inward toward the individual with sufficient force to cause the pressure point knob to press into the individual's flesh. The force behind the pressure point knob is provided by the tension of a strap or harness that is fashioned to hold the contoured panel firmly against the individual's body.

As the individual wearing the novel therapeutic device goes about their routine daily activities, their body's natural motion causes small deviations in the pressure point knob's position which causes the directly corresponding tissue to be repeatedly compressed and released. If the pressure point knob is correctly aligned with dysfunctional myofascial tissue, this repetitious motion mimics physical manipulation myofascial release therapy performed by a practitioner.

The intensity of the therapy can be controlled by the number and size of the pressure point knobs as well as the force with which they are pressed into the individual's flesh. As previously mentioned, the tension with which the strap or harness holds the contoured panel against the individual's body contributes to the force with which the pressure point knobs are pressed against the individual. However, the greater the size of the pressure point knob, the deeper the pressure point knob might press into the individual's flesh at any given level of tension.

In some embodiments, the pressure point knobs may be interchangeable so that the individual can adjust the intensity of the therapy by changing the size of pressure point. In such embodiments the pressure point knobs may be detachably coupled with the contoured panel such that they can be removed and replaced with either a bigger or smaller pressure point knob depending on preference. In other embodiments the pressure point knobs may be adjustable such that an individual can alter the size of a pressure point knob without the need of swapping it for a larger or smaller one.

It is contemplated that an individual suffering from myofascial pain or discomfort might initially visit a practitioner for traditional myofascial release therapy and then be fitted with the presently disclosed novel therapeutic device so that the individual can receive ongoing therapy between in-person sessions. In this capacity, the practitioner may assist in choosing the initial configuration and intensity of the device and can make adjustments to the device in subsequent in-person session as the therapy progresses.

In some embodiments the device may also be combined with other holistic therapies such as crystal therapy. While myofascial therapy is based on the physical manipulation of dysfunctional tissue, crystal therapy is based on balancing the bodies energies systems. By incorporating various crystals into the pressure point knobs, the presently disclosed therapeutic device can combine both myofascial release therapy with crystal therapy and achieve synergistic results greater than either technology alone.

It is also important to note that the presently disclosed invention is not limited to human use; some embodiments can be can be adapted for veterinary purposes. Both large and small animals regularly suffer from myofascial related pain, discomfort, or stiffness in the same manner as humans and can similarly benefit from myofascial release therapy. The adaptability of the presently disclosed design allows for customization to suit various different animal sizes and body types, making it a versatile tool for promoting healing and wellness in a wide various species.

This disclosure teaches certain benefits in construction and use which give rise to the objectives described below:
A primary objective inherent in the above described apparatus is to provide advantages not taught by the prior art;
Another objective is to provide a novel therapeutic device designed to relieve myofascial pain, discomfort, stiffness, and tension;
A further objective is to provide a novel wearable therapeutic apparatus that is capable of harnessing and channeling a person's everyday movements into therapeutic manipulation of dysfunctional myofascial tissue;
A still further objective is to provide a novel low cost therapeutic apparatus that is capable of extending the benefits of in-person myofascial physical therapy with a practitioner by providing continuous complimentary therapy via a wearable therapy;
Other features and advantages of the present invention will become apparent from the following more detailed descriptions, taken in conjunction with the accompanying drawings, which illustrate, by way of example, the principles and features of the presently described apparatus.

### BRIEF DESCRIPTION OF THE SEVERAL VIEWS OF THE DRAWINGS

The accompanying drawings illustrate various exemplary implementations and are part of the specification. The illustrated implementations are proffered for purposes of example not for purposes of limitation. Illustrated elements will be designated by numbers. Once designated, an element will be identified by the identical number throughout. Illustrated in the accompanying drawing(s) is at least one of the best mode embodiments of the present disclosure. In such drawing(s):

FIG. 1 is a perspective view of one embodiment of the presently disclosed novel therapeutic device configured for the upper forearm featuring two contoured panels, one contoured panel with three pressure point knobs and one contoured panel with one larger pressure point knob;

FIG. 2 is a perspective view of the embodiment of the presently disclosed therapeutic device illustrated in FIG. 1 shown in a circumferential orientation as if being wrapped around an individual's arm;

FIG. 3 is a perspective view of an individual wearing the presently disclosed therapeutic device illustrated in FIGS. 1 and 2, one on each arm;

FIG. 4 is a cross-section plan view of the embodiment of the therapeutic device illustrated in FIG. 1 shown in a circumferential orientation wrapped around an individual's arm, the cross-section of the individual's arm is illustrated as the hashed area;

FIG. 5 is an exploded perspective view of a contoured panel of the presently disclosed therapeutic device featuring three pressure point knobs, one pressure point knob is illustrated affixed to the contoured panel and two pressure point knobs are illustrated in an exploded orientation showing that the pressure point knobs are attached to the contoured panel by a coupling mechanism comprising a threaded hole in the contoured panel designed to accept a threaded stud feature on the pressure point knob;

FIG. 6 is an exploded perspective view of an embodiment of the presently disclosed therapeutic device featuring a contour panel with three adjustable pressure point knobs, two such knobs are illustrated affixed to the contoured panel and one pressure point knob is illustrated in an exploded orientation indicating that, in this embodiment, the pressure point knobs are detachable using a threaded coupling mechanism;

FIG. 7 is a side plan view of an embodiment of the pressure point knob featuring a threaded stud on one end for detachably coupling with the contoured panel and a threaded stud on the other end for adjusting the size of the pressure point knob;

FIG. 8A is a cutaway plan view of the size-adjustable pressure point knob featured in FIG. 7 illustrating that the tip of the size-adjustable pressure knob can be extended by manipulating a threaded coupling mechanism;

FIG. 8B is a cutaway plan view of the size-adjustable pressure point knob featured in FIG. 7 illustrating that the tip of the size-adjustable pressure knob can be fully decoupled by manipulating a threaded coupling mechanism;

FIG. 9 is an exploded perspective view of an embodiment of the presently disclosed therapeutic device featuring a contour panel with three adjustable pressure point knobs made of crystal, two such knobs are illustrated affixed to the contoured panel and one crystal pressure point knob is illustrated in an exploded orientation such showing that, in this embodiment, the crystal pressure point knobs are detachable via a threaded coupling mechanism;

FIG. 10 is a plan side view of the pressure point knob made of crystal as is featured in FIG. 9 illustrating that, in this embodiment, the crystal can be attached to a coupling pedestal via a threaded coupling mechanism;

FIG. 11 is a cutaway side plan view of the pressure point knob made of crystal featured in FIG. 9 illustrating the crystal pressure point knob fully coupled with a coupling pedestal via a threaded coupling mechanism;

FIG. 12 is a perspective view of an embodiment of the presently disclosed novel therapeutic device featuring a rectangular contoured panel capable of supporting as many as ten (10) pressure point knobs; however, only six (6) are presently illustrated, five (5) of which are shown coupled with the contoured panel and one (1) is shown in an exploded view demonstrating the pressure point knobs couple with the contoured panel via a threaded coupling mechanism;

FIG. 13 is a perspective view of the embodiment of the presently disclosed novel therapeutic device shown in FIG. 12 illustrated supporting all ten (10) pressure point knobs which the embodiment is capable, this view is shown to contrast FIG. 12 to demonstrate that the device can be customized by adjusting the number and position of the pressure point knobs to achieve the desired therapeutic effect;

FIG. 14 is a perspective view of an individual wearing an embodiment of the presently disclosed novel therapeutic medical device that includes a rectangular contoured panel supporting ten (10) pressure point knobs and a harness or truss to support the contoured panel along the erector spinae and/or trapezius muscles.

FIG. 15 is a perspective view of an individual wearing an embodiment of the presently disclosed novel therapeutic medical device that includes a rectangular contoured panel supporting ten (10) pressure point knobs and harness or truss to support the contoured panel on the individual's infraspinatus muscles.

### DETAILED DESCRIPTION OF THE EXEMPLARY EMBODIMENTS

The above described drawing figures illustrate multiple exemplary embodiments of the presently disclosed apparatus and its many features in at least one of its preferred, best mode embodiments, which is further defined in detail in the following description. Those having ordinary skill in the art may be able to make alterations and modifications to what is described herein without departing from its spirit and scope of the disclosure. Therefore, it must be understood that what is illustrated is set forth only for the purposes of example and that it should not be taken as a limitation in the scope of the present apparatus or its many features.

Described now in detail is a novel, wearable therapeutic medical device that seamlessly integrates myofascial release therapy technology into an individual's daily life.

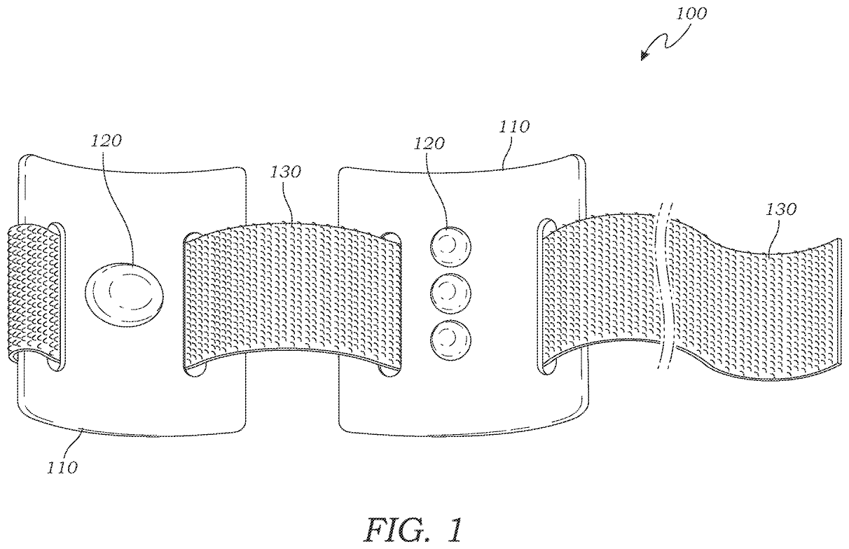

FIG. 1 illustrates an exemplary embodiment of the presently disclosed invention 100 featuring a flexible strap 130 that is configured to securely support two contoured panels 110. In the present embodiment, the strap 130 securely supports the contoured panels via a “slotted strap” configuration in which the strap 130 passes through a narrow slit feature located along on each edge of the contoured panel 110 allowing the strap 130 to dictate the position of the contour panels 110. The illustrated mechanism is an exemplar embodiment, other means and mechanisms for securing attaching the strap 130 to the contoured panel 110 are possible.

The contoured panels 110 are described as contoured panels 110 because they are contoured to a shape of the particular body part they are designed to complement, whether the recipient body is a human body or animal body. Each contoured panel 110 features at least one pressure point knob 120. In the embodiment illustrated in FIG. 1, one contoured panel 110 features three pressure point knobs 120 and the other contoured panel 120 features a single, larger pressure point knob 110. Different embodiments of the presently disclosed apparatus 100 may feature different numbers of pressure point knobs 110, different size pressure point knobs 110, and the pressure point knobs 110 may be arranged in different configurations to tailor the therapeutic effect to the unique needs of the individual being treated.

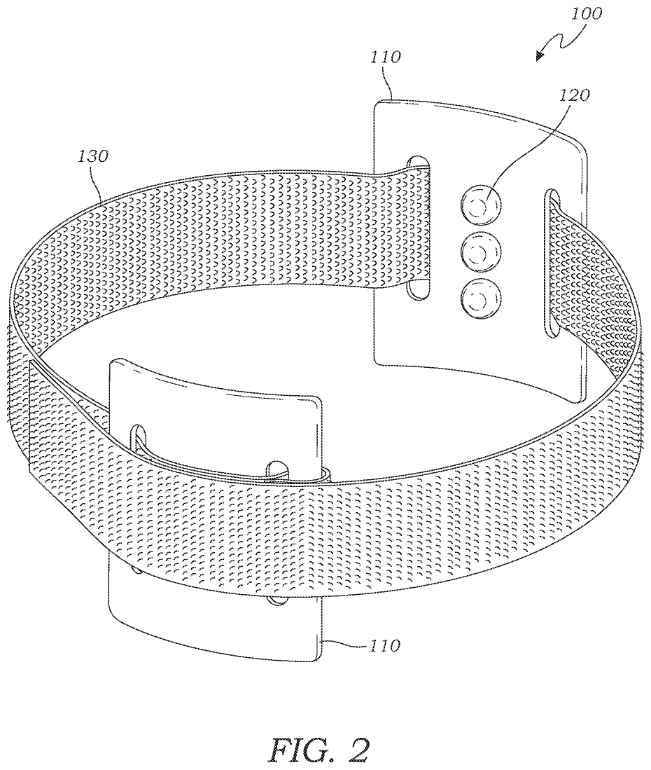

FIG. 2 illustrates the same embodiment of the presently disclosed apparatus 100 featured in FIG. 1 shown in a circumferential arrangement with the terminal ends of the strap 130 affixed to each other so that the strap 130 can wrap around the wearing individual's arm, leg, or other body part in a length adjustable manner to provide sufficient tension to support the contoured panels 110 in the desired location(s) and provide the appropriate force to the pressure point knob(s) 130 so that they can press into the individual's tissue with sufficient force to effect the desired therapeutic manipulation. In the illustrated embodiment 100, the strap 130 features a hook and loop fastening system to allow the terminal ends of the strap 130 to detachably affix to each other upon contact. Other embodiments may use other legacy methods of attachment such as buttons, buckles, snaps, and/or magnets, or even novel attachment mechanisms so long as the terminal ends of the strap 130 can affix to each other such that the strap 130 can provide adequate tension to support the contoured panels 110 in the desired location and provide sufficient force to the pressure point knob(s) 120 to affect their purpose.

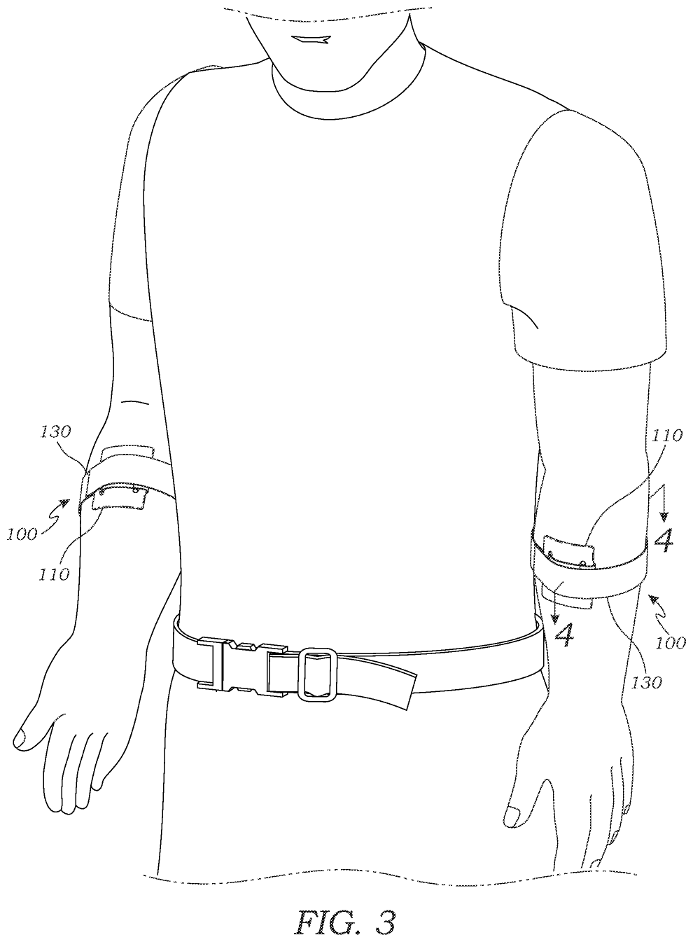

FIG. 3 illustrates an individual wearing the embodiment 100 featured in both FIGS. 1 and 2, one device on each forearm. As previously described, in this embodiment, the terminal ends of the straps 130 are affixed to each other using a hook and loops system providing desired tension to hold the contoured panels 110 in place such that the pressure point knobs 120 are located proximal to the individual's pre-identified dysfunctional myofascial tissue, or trigger points, and are provided with sufficient force to press into the individual's flesh in such locations.

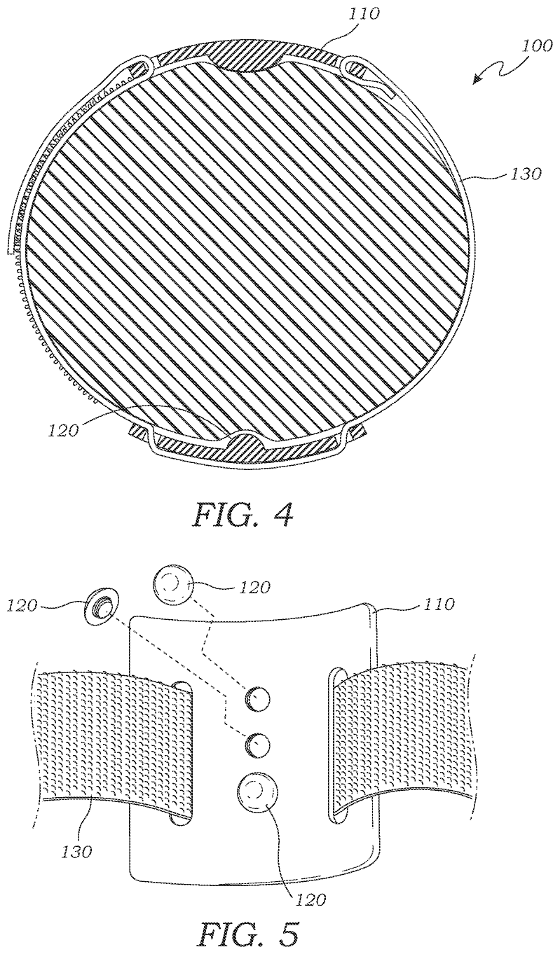

FIG. 4 is cross-section of the embodiment of the presently disclosed apparatus featured in FIG. 3 across plane four (4) as indicated by the arrows in FIG. 3. The individual's forearm is depicted by hatched shading in the center of the illustration. This view is included to illustrate that when the strap 130 is oriented in a circumferential manner around the individual's arm holding the contoured panels 110 in a firm and secure manner against the individual's arm with sufficient force, the pressure point knobs 120 are pressed into the flesh of the arm. The compression caused by the pressure point knobs 120 compress, release, and otherwise mechanically massages and manipulates tissue in the immediate area of the pressure point knob 120 as the wearing individual moves as they go about their daily activities. The tension of the strap 130 can be adjusted for both comfort and to control the intensity of the therapy.

FIG. 5 illustrates an embodiment of the presently disclosed invention 100 in which the pressure point knobs 120 are detachable from the contoured panel 110. In this embodiment, the pressure point knobs 120 are detachable via a reversible helical coupling system including a helically threaded hole in the contour panel 110 and a complimentary sized helically threaded stud feature of the pressure point knob 120. This feature allows the pressure point knobs 120 to be attached and detached from the contour panel 110 at will. This feature also allows the pressure point knobs 120 to be swapped out for either larger or smaller pressure point knobs 120 to control the intensity of the therapy.

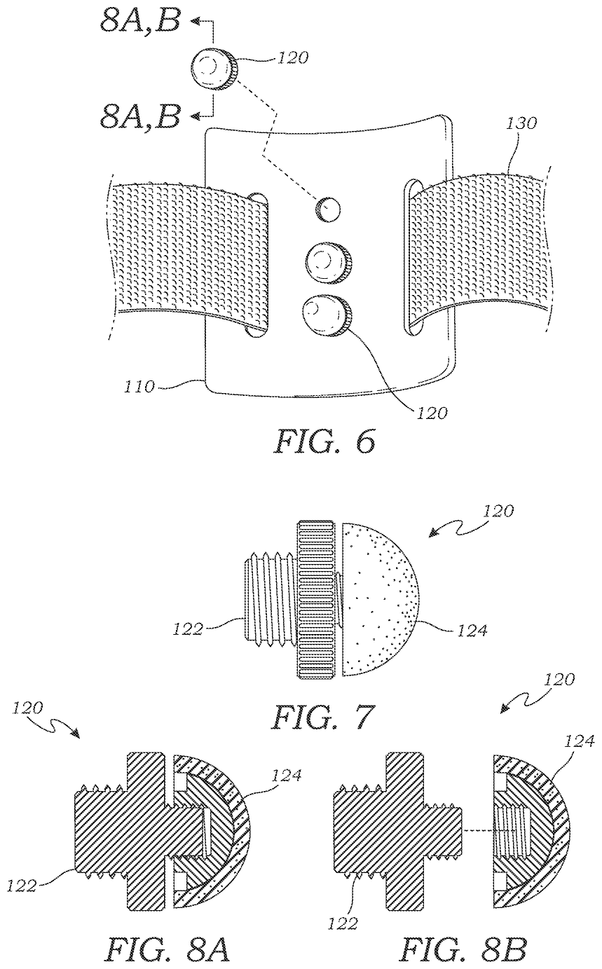

FIG. 6 illustrates an embodiment of the presently disclosed invention 100 in which the pressure point knobs 120 are size-adjustable, thereby facilitating the increase or decrease of the therapeutic intensity without the need to physically swap the pressure point knobs 120. The presently disclosed apparatus 100 contemplates both interchangeable pressure point knobs 120 and/or any manner of size or shape adjustable pressure point knobs 120.

The size-adjustable pressure point knobs 120 featured in FIG. 6 is further illustrated in FIGS. 7, 8A, and 8B. FIG. 7 illustrates a side plan view of the of the size-adjustable pressure point knob 120 comprised of two component parts, a knob base 122 and a knob cap 124. The knob base 122 and knob cap 124 are also adjoined using a helically threaded coupling mechanism. FIGS. 8A and 8B are cutaway plan views that provide more visual detail as to how the knob base 122 and the knob cap 124 interface and its key features, specifically, that the size of this pressure point knob 120 embodiment can be increased by rotating the knob base 122 with respect to the knob cap 124. This feature is especially convenient for myofascial therapy regimens that include increasing or decreasing intensity over time.

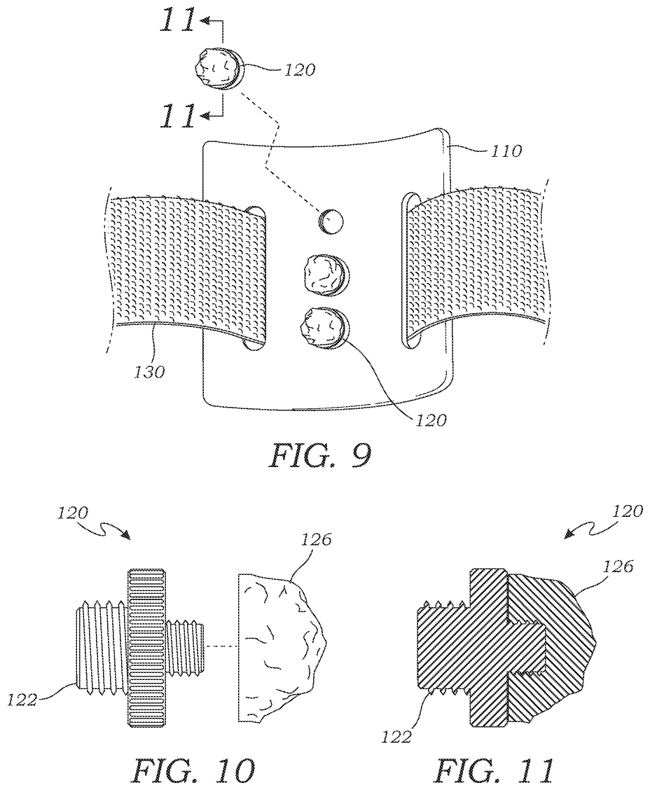

FIG. 9 illustrates the inclusion of other therapeutic modalities. In this embodiment of the presently disclosed apparatus 100, the pressure point knobs 122 are capped with crystals and/or gemstones 126 that can influence and balance energy fields within the body as well as provide the physical manipulation of targeted tissue traditionally associated with myofascial therapy. This dual approach can achieve greater synergetic affects than either therapeutic modality alone. FIGS. 10 and 11 illustrate one possible manner in which crystals or gemstones 126 can be incorporated into a pressure point knob 120, specifically, by mounting the crystal or gemstone 126 on a knob base 122 such that the crystal or gemstone serves as the knob cap 126. This embodiment contemplates a broad range of coupling mechanism by which a crystal or gemstone may be incorporated into a pressure point knob 120. The specific coupling mechanism illustrated in FIGS. 10 and 11 is provided for example only and is not meant to be limiting.

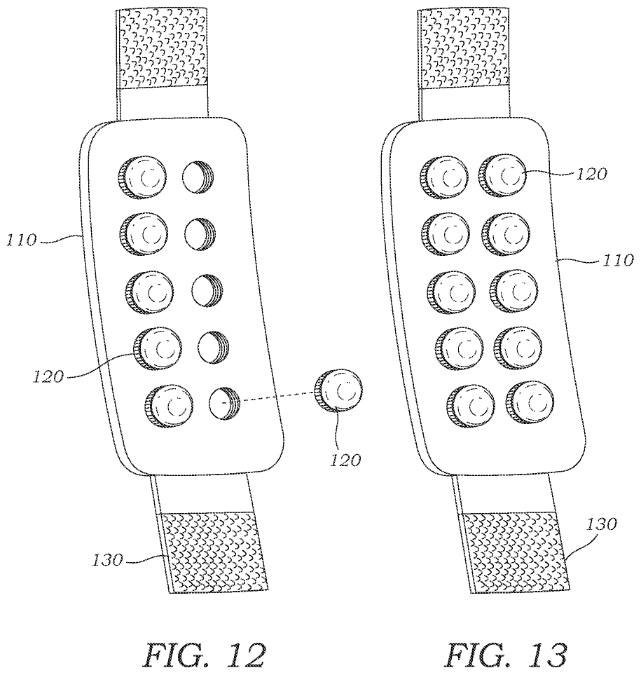

FIGS. 12 and 13 illustrate an embodiment of the presently disclosed apparatus 100 that features an extended rectangular shaped contour panel 110 capable of supporting an array of pressure point knobs 120. This embodiment is included to emphasize that the contour panels 110 can vary across a wide spectrum of shapes and sizes depending on the body part it is designed to complement and the individual's particular therapeutic needs. In the embodiment illustrated in FIGS. 12 and 13, the difference between the two illustrations demonstrates that a therapeutic practitioner can choose whether or not to populate the entire array of pressure point knobs 120 to achieve the desired therapeutic effects.

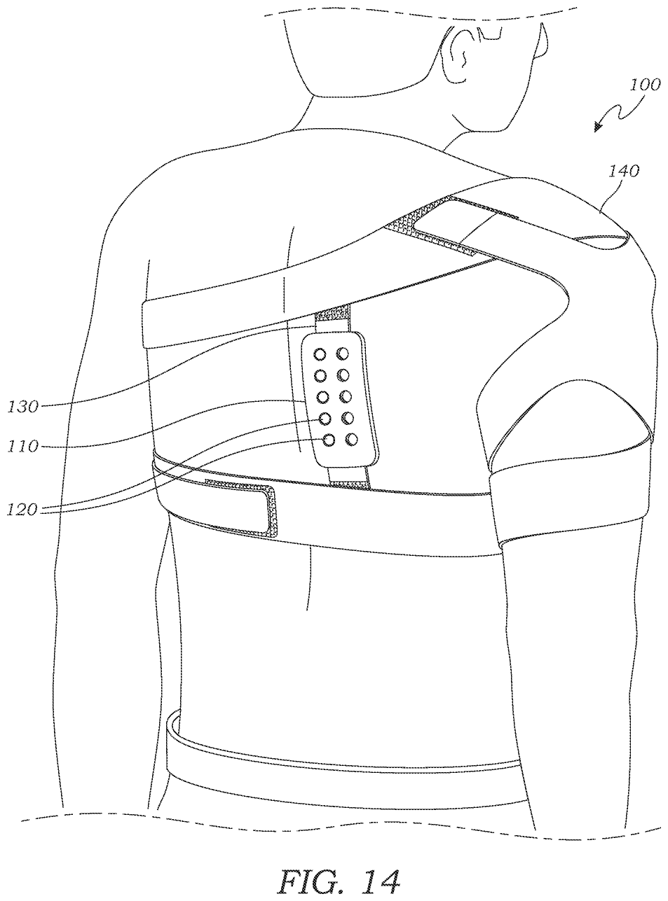

FIG. 14 illustrates an embodiment configured to address dysfunction surrounding the erector spinae and/or trapezius muscles. In order to properly support the contoured panel 110 and the pressure point knobs 120 in this embodiment, additional support is needed in the form of chest and shoulder harness. The illustrated embodiment shows the straps 130 extending between the contoured panel 110 and harness 140. A harness 140 may be included anytime the targeted body part cannot be easily circumwrapped by the strap 130 alone. It is contemplated that the harness may take on many forms in order to securely attach to the individual's body in a manner that can provide firm and secure support for the contoured panel 110 in the location targeted by the therapy.

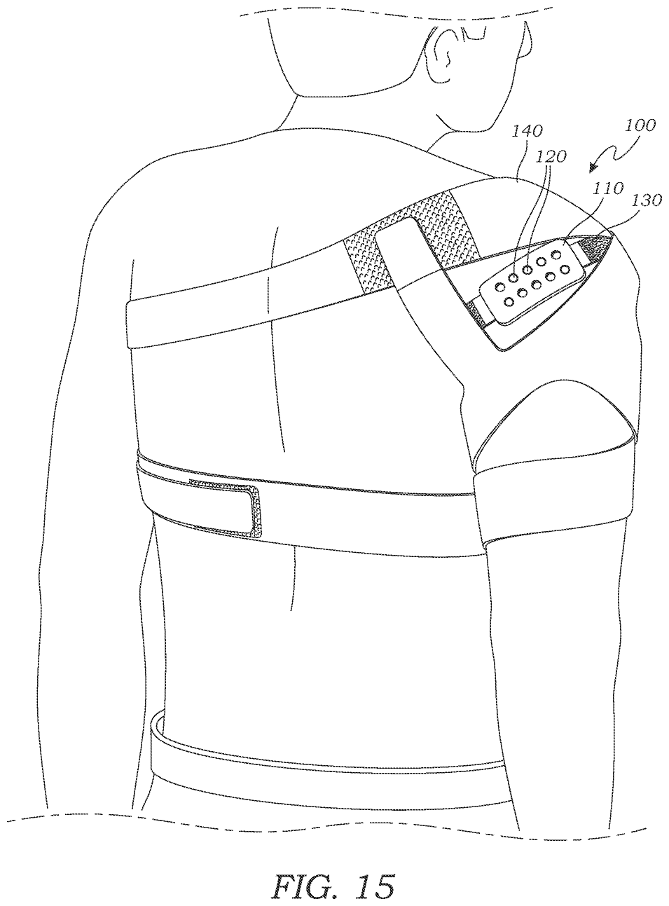

FIG. 15 illustrates a very similar chest and shoulder harness 140 except that, in this exemplar embodiment 100, the contoured panel 110 is positioned to treat the tissue surrounding the infraspinatus muscles. As in the embodiment 100 depicted in FIG. 14, the strap 130 firmly secures the contoured panel 110 in place by tethering the contoured panel 110 to the harness 140 such that the contoured panel 110 and pressure point knobs 120 are located above the dysfunctional tissue targeted for therapy. It is further contemplated that some embodiments 100 may include a “harness” 140 that comprises of compression clothing that featuring pockets or other means of securing the contour panel 110 in place without the need of straps 130. The purpose of the straps 130 and the harness 140 are to hold the contour panel 110 in place with sufficient force to allow the pressure point knobs 120 to compress the targeted tissue. It is contemplated that in other embodiments this function will be achieved by other methods.

The enablements described in detail above are considered novel over the prior art of record and are considered critical to the operation of at least one aspect of the apparatus and its method of use, and to the achievement of the above-described objectives. The words used in this specification to describe the instant embodiments are to be understood not only in the sense of their commonly defined meanings, but to include by special definition in this specification: structure, material, or acts beyond the scope of the commonly defined meanings. Thus, if an element can be understood in the context of this specification as including more than one meaning, then its use must be understood as being generic to all possible meanings supported by the specification and by the word(s) describing the element.

The definitions of the words or drawing elements described herein are meant to include not only the combination of elements which are literally set forth, but all equivalent structures, materials or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, substitutions, now or later known to one with ordinary skill in the art, are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A therapeutic apparatus that is wearable by the recipient of the therapy, said apparatus comprising:
at least one contoured panel that is shaped to compliment the contours of the part of the recipient's body intended for myofascial therapy, said contoured panel featuring an internal surface that faces the recipient's body when worn and an external surface that faces away from the recipient's body when worn;
at least one pressure point knob that is affixed to said contoured panel such that said pressure point knob is protruding from the internal surface of said contour panel;
at least one strap affixed to said contoured panel in at least one location such that said strap is capable of securely holding said contoured panel proximate the part of the recipient's body that is intended for myofascial therapy when worn.

2. As apparatus as in claim 1 further including a harness configured to securely attach to the recipient's body affixed to said strap such that said harness and said strap are capable of securely holding said contoured panel proximate the part of the recipient's body that is intended for myofascial therapy when worn.

3. As apparatus as in claim 1 further including a harness configured to securely attach to a recipient's body and detachably affixed to said contoured panel such a that said harness is capable of securely holding said contoured panel proximate the part of the recipient's body that is intended for myofascial therapy when worn.

4. An apparatus as in claim 1 wherein said pressure point knobs are detachably affixed to said contoured panel.

5. An apparatus as in claim 1 wherein said pressure point knobs are size-adjustable.

6. An apparatus as in claim 1 wherein said pressure point knobs contain healing crystals.
